(19) United States
(12) Patent Application Publication
(10) Pub. No.: US 2005/0284182 A1
(43) Pub. Date: Dec. 29, 2005

(54) Manufacturing method of optical fiber and optical fiber

(76) Inventors: Toshiki Taru, Yokohama-shi (JP); Shinji Ishikawa, Yokohama-shi (JP); Tetsuya Haruna, Yokohama-shi (JP); Motoki Kakui, Yokohama-shi (JP); Takahiro Murata, Onojo-shi (JP)

Correspondence Address: MCDERMOTT WILL & EMERY LLP, 600 13TH STREET, N.W., WASHINGTON, DC, 20005-3096, US

(21) Appl. No.: 11/102,877

(22) Filed: Apr. 11, 2005

(30) Foreign Application Priority Data
Apr. 12, 2004 (JP) P2004-117044

(51) Int. Cl. C03B 37/075

(52) U.S. Cl. 65/390

(57) ABSTRACT

There is disclosed a method of manufacturing an optical fiber whose core is made of multi-component glass without fluctuation in its outer diameter and occurrence of sudden breakage thereof, with a technique of unifying a core rod and a cladding tube at the time of drawing, and yet drawing them; and the optical fiber having a multi-component glass core are disclosed.

### BACKGROUND OF THE INVENTION

1. Field of the Invention

The present invention relates to a manufacturing method of an optical fiber having a multi-component glass core and the optical fiber.

2. Related Background of the Invention

As one of the manufacturing methods of an optical fiber, the method; in which in a state where a softened core raw material is filled in a hollow part of the tube, which is obtained by disposing a solid core raw material in the hollow glass tube having a cladding structure and heating them, they are drawn as they stand; has been proposed. According to this method, the core raw material, which has been melted and adapted on the inside wall of the hollow part of the cladding tube, can be immediately fiberized in this state. Therefore, this method is considered to have the following advantages: (a) this method does not require a polishing process for smoothing the surface of the core rod, which a rod-in-tube method requires; and (b) with this method, the optical fiber of which a core material is multi-component glass containing a large amount of oxides, can be formed, which is difficult to obtain with a CVD method (refer to Patent Document 1).

However, with the method disclosed by the above-described document, when the core material made of multi-component glass (hereinafter, also referred to as a multi-component glass core), which has been disposed in a cladding tube made of silica glass, is heated and drawn, there may be cases that the fluctuation in the outer diameter of the drawn fiber becomes large, and this results in breakage of the fiber and its stable drawing becomes difficult.

[Patent Document 1] Japanese Unexamined Patent Publication (Kohyo) No. 2002-529357

### SUMMARY OF THE INVENTION

It is therefore an object of the present invention to provide a manufacturing method of an optical fiber having a multi-component glass core with less fluctuation in its outer diameter and less breakage.

An aspect of the present invention is to provide a manufacturing method of an optical fiber in which a core rod and a cladding tube are unified at the time of drawing, wherein the core rod is made of multi-component glass and the cladding tube is made of silica glass containing a dopant.

Another aspect of the present invention is to provide a manufacturing method of an optical fiber in which the dopant is a halogen element.

A further different aspect of the present invention is to provide a manufacturing method of an optical fiber in which the amount of the dopant of the halogen element is 1.0 wt. % or more.

A further different aspect of the present invention is to provide a manufacturing method of an optical fiber in which the drawing is executed at a drawing temperature of 1800° C. or less.

A further different aspect of the present invention is to provide a manufacturing method of an optical fiber in which the drawing is executed at drawing tension of 0.3 N or more.

A further different aspect of the present invention is to provide the manufacturing method of the optical fiber described above (1), in which the core rod is made of multi-component glass containing one kind or more of oxides selected from a group of oxides of 3A, 2B, 3B, and 5B group elements and oxides of rare earth elements in the periodic table.

A further different aspect of the present invention is to provide the manufacturing method of the optical fiber described above (1), in which the core rod is made of multi-component glass containing two kinds or more of oxides selected from a group of oxides of 3A, 2B, 3B, and 5B group elements and oxides of rare earth elements in the periodic table.

A further different aspect of the present invention is to provide an optical fiber, which is formed by unifying a core rod made of multi-component glass containing at least one kind or more of oxides selected from a group of oxides of 3A, 2B, 3B, and 5B group elements and oxides of rare earth elements in the periodic table, and a cladding tube made of silica glass containing a dopant at the time of drawing, and drawing them.

### BRIEF DESCRIPTION OF THE DRAWINGS

FIGS. 1A and 1B are conceptual diagrams for explaining the present invention, and FIG. 1A shows a state before a drawing process and FIG. 1B shows a state after the drawing process.

### DESCRIPTION OF THE PREFERRED EMBODIMENTS

The inventors of the present invention have researched and examined again and again the problems that the fluctuation in the outer diameter of the drawn fiber becomes large, and this results in breakage of the fiber in the conventional method in which the solid multi-component glass core rod material, which has been disposed inside a silica cladding tube in advance, is heated/drawn and fiberized, and as a result, the inventors have reached a conclusion that the problems are caused by that a part of the components of the multi-component glass material is vaporized in a high temperature environment and this results in generation of bubbles.

Therefore, according to the present invention, by using silica glass containing a dopant as a material of the cladding tube, the viscosity of the cladding tube is lowered, and the drawing temperature is lowered, and vaporization of the multi-component glass of the core material is prevented, and the problems of the generation of bubbles, breakage, and structurally irregular loss by the bubbles are solved.

According to the present invention, a part or all of the cladding tube is made of silica glass containing a dopant, and the dopant, which allows the viscosity to be lowered at the time of drawing, is acceptable, for example, halogen elements, such as F and Cl, B and P and the like can be used, and especially, a halogen element is preferable.

The reason why the halogen element is especially preferable comes form the following (1) to (3).
(1) It is easy that the halogen element is uniformly added in glass.
(2) Even the halogen element is added in the glass in a small amount, the viscosity is lowered relatively largely.
(3) The glass in which the halogen element was added is stabilized and is difficult to crystallize.

According to the present invention, as the dopant in the cladding tube, fluorine (F) has an advantage especially. As the reasons, it is easy that F is uniformly added in glass, the effect of lowering the viscosity for the amount of addition is large, and further, the glass having F added is stable.

In a table 1, a relation between the amount of F (wt. %) added in SiO₂ and the viscosity (η) (Pa.s) at a temperature of 1800° C. is shown.

TABLE 1

| F (%) | H (Pa · s) |
|---|---|
| 0 | 1 × 10^{5.8} |
| 1 | 1 × 10^{5.4} |
| 2 | 1 × 10^{4.9} |
| 3 | 1 × 10^{4.5} |

Specifically, when the amount of the halogen element contained in the silica glass being the cladding tube material is preferably 1 wt. % or more, there is an advantage that the above-described effects are large. More preferably, it is 2 wt. % or more. The upper limit of the amount of the halogen element contained in the silica glass is approximately 3 wt. %, for example, in case of fluorine, and this is the upper limit in the meaning of the dopant amount enabling the industrially efficient production.

The cladding tube having the dopant added in the entire tube can be manufactured by the following processes: for example, by sintering a porous glass particle deposited body deposited with a VAD method in an atmosphere including a dopant raw material, a transparent glass body containing the dopant is obtained, and by machining and heating/elongating this glass body, the cladding tube is formed.

As the multi-component glass being the core rod material of the present invention, glass made of SiO₂ containing one kind or more of oxides of elements selected from a group of oxides, for example, of 3A group elements, 2B group elements, 3B group elements, 5B group elements and/or rare earth elements in the periodic table can be used.

Specifically, as the oxide of the element to be contained in such SiO₂, for example, Y₂O₃, ZnO, B₂O₃, Al₂O₃, P₂O₅, Li₂O, Ga₂O₃, Ta₂O₅, Bi₂O₃, Sb₂O₃, TiO₂, Nb₂O₅, Er₂O₃, Nd₂O₃, Yb₂O₃, Tm₂O₃ and the like can be used.

The core rod made of such multi-component glass can be formed by the method etc., for example, in which raw material powders are mixed and melted in a crucible, and the mixed and melted powders are cast in a die made of carbon.

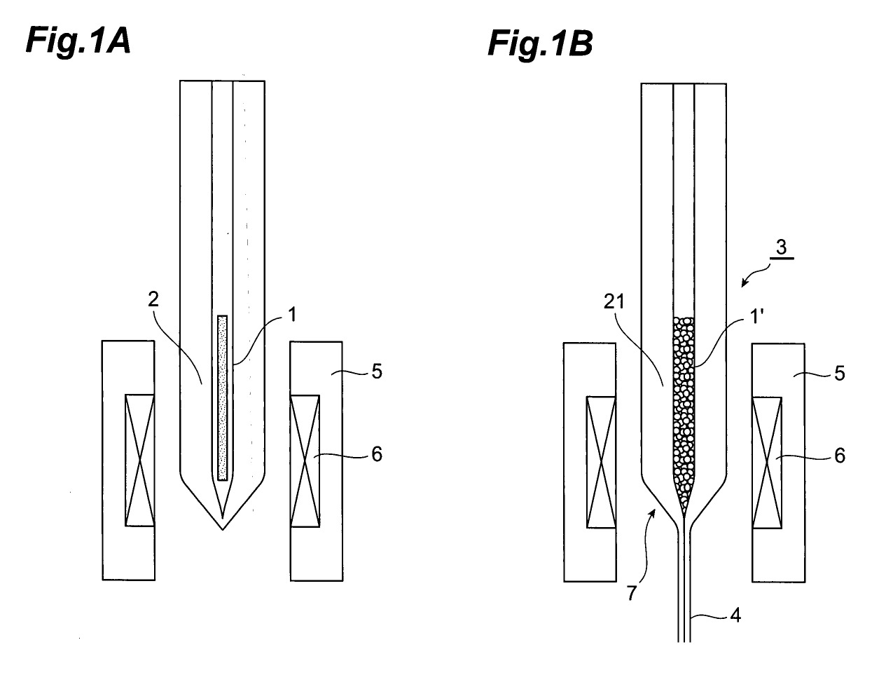

FIGS. 1A and 1B are conceptual diagrams for explaining a manufacturing method of the present invention, and FIG. 1A shows a state before a drawing process and FIG. 1B shows a state during the drawing process. That is, a core rod 1 made of multi-component glass, which has been disposed in a cladding tube 2 made of silica containing a dopant, is inserted into a drawing furnace 5 (FIG. 1A), heated by a heater 6, and drawn. At this time, a core rod 1′, which came into a melted state, is unified with a cladding tube 2′, which was softened, and is drawn into an optical fiber 4 (FIG. 1B).

The drawing temperature according to the present invention is 1900° C. or less and more preferably, 1800° C. or less, and the temperature of 1800° C. or less is desirable in that the effect that the vaporization of the core material and the generation of bubbles and the like can be avoided is considerably. The minimum temperature at which the cladding glass can be drawn decides the lowest limit of the drawing temperature.

The tensile force at the time of the drawing can be selected arbitrarily, however, the tensile force of 0.3 N (corresponding to approximately 30 gf) or more is preferable because the drawing temperature can be kept at 1800° C. or less, and when the tensile force exceeds 1.5 N, there may be cases that the fiber is broken.

### EXAMPLE 1

In the configuration shown in FIGS. 1A and 1B, as the core rod 1, the multi-component glass core rod; which is composed of 32 wt. % of Al₂O₃, 20 wt. % of Y₂O₃, 0.1 wt. % of Er₂O₃, and SiO₂ being the remaining part; is prepared, and the cladding tube 2 made of SiO₂ containing 3 wt. % of F (F is added homogeneously in the entire tube) is prepared. The core rod 1 is 6 mm Φ in outer diameter and 200 mm in length, and the cladding tube 2 is 40 mm in outer diameter, 8 mm in inner diameter, and 400 mm in length. The core rod 1 and the cladding tube 2, which have not been unified at a stage of a preform, are unified at the time of heating and drawing by the drawing furnace 5. When the drawing is applied to form the optical fiber 4 whose outer diameter is 125 μm under the conditions that the drawing tension is 0.1 to 0.8 N, the drawing tension at the steady state is 0.6 N, the drawing speed is 100 m/minute, and the drawing temperature is 1750° C. (furnace temperature), the fluctuation in the glass diameter is small, and the sudden breakage is not generated.

### COMPARATIVE EXAMPLE 1

Under the same conditions of the example 1 except that the material of the cladding tube 2 is pure silica (SiO₂), the unifying process is executed at the time of drawing, and the drawing process is executed. When the furnace temperature is adjusted in order to meet the drawing tension, 2000° C. is required in this comparative example, and the sudden fluctuation in the fiber outer diameter is large, and the breakage of the fiber often occurs during the drawing process. Observation of a part having gradually reduced diameter 7 of a base material to be drawn 3 visually demonstrates that bubbles are contained.

According to the present invention, the material made of silica glass containing a dopant is used as the cladding tube, and the viscosity of this silica glass containing the dopant is lower than that of pure silica glass (SiO₂), so the drawing can be executed at a lower temperature than the case of the pure silica glass cladding. Consequently, the vaporization and the generation of bubbles of the multi-component glass being the core material do not occur and the problems that the generation of bubbles and the sudden breakage can be avoided. It is difficult to manufacture the optical fiber having a multi-component glass core with the CVD method, however, according to the present invention, the optical fiber can be actually manufactured in an excellent yield.

1. A method of manufacturing an optical fiber, in which a core rod and a cladding tube are unified at the time of drawing, wherein the core rod is made of multi-component glass, and the cladding tube is made of silica glass containing a dopant.

2. The method of the optical fiber according to claim 1, wherein the dopant is a halogen element.

3. The method of the optical fiber according to claim 2, wherein the amount of the dopant of the halogen element is 1.0 wt. % or more.

4. The method of the optical fiber according to claim 1, wherein the drawing is executed at a drawing temperature of 1800° C. or less.

5. The method of the optical fiber according to claim 1, wherein the drawing is executed at drawing tension of 0.3 N or more.

6. The method of the optical fiber according to claim 1, wherein the core rod is made of multi-component glass containing one kind or more of oxides selected from a group of oxides of 3A, 2B, 3B, and 5B group elements, and oxides of rare earth elements in the periodic table.

7. The method of the optical fiber according to claim 1, wherein the core rod is made of multi-component glass containing two kinds or more of oxides selected from a group of oxides of 3A, 2B, 3B, and 5B group elements, and oxides of rare earth elements in the periodic table.

8. An optical fiber, which is formed by unifying a core rod made of multi-component glass containing at least two kinds or more of oxides selected from a group of oxides of 3A, 2B, 3B, and 5B group elements, and oxides of rare earth elements in the periodic table, and a cladding tube made of silica glass containing a dopant at the time of drawing and drawing them.

9. A manufacturing method of an optical fiber, comprising:
a first preparation step of preparing a core rod made of multi-component glass;
a second preparation step of preparing a cladding tube containing a dopant; and
a drawing step of inserting the prepared core rod in the prepared cladding tube, and drawing them for unification.

10. The method of the optical fiber according to claim 9, wherein the drawing in the drawing step is executed at a drawing temperature of 1800° C. or less.

11. The method of the optical fiber according to claim 9, wherein the drawing is executed at drawing tension of 0.3 N or more.

12. The method of the optical fiber according to claim 9, wherein the dopant is a halogen element.
